(19) United States
(12) Patent Application Publication
(10) Pub. No.: US 2024/0286136 A1
(43) Pub. Date: Aug. 29, 2024

(54) TEST TUBE CAPPER-DECAPPER FOR STANDARD TEST TUBE RACKS WITH A DISPLACEABLE CAP GRIPPER

(71) Applicant: LABSOLUZ APS, Karlslunde (DK)

(72) Inventors: Stig CHRISTENSEN, Karlslunde (DK); Lars Weber HOVENDAHL, Karlslunde (DK)

(73) Assignee: LABSOLUZ APS, Karlslunde (DK)

(21) Appl. No.: 18/562,982

(22) PCT Filed: May 23, 2022
(86) PCT No.: PCT/EP2022/063926

§ 371 Date: Nov. 21, 2023

(30) Foreign Application Priority Data
May 21, 2021 (DK) PA202100530

(51) Int. Cl. B01L 3/00; B67B 3/20; B67B 7/18

(52) U.S. Cl. CPC B01L 3/50825; B67B 3/2066; B01L 2300/042; B67B 7/182

(57) ABSTRACT

The present disclosure relates to a test tube capper-decapper device comprising an arrangement for switching an array of cap grippers comprising at least three cap grippers between a one-dimensional array of cap grippers and a two-dimensional array of cap grippers, an arrangement for being comprised within a test tube capper/decapper device, whereby it is made possible to switch an array of cap grippers comprising at least three cap grippers between a one-dimensional array of cap grippers and a two-dimensional array of cap grippers by action of a switch on the array of cap grippers, whereby the versatility of the test tube capper/decapper device can be increased.

### TECHNICAL FIELD

In the field of capping and decapping of test tubes held in a standard rack for holding test tubes there is proposed a handheld test tube capper-decapper having a versatile gripper alignment for using the handheld test tube capper-decapper with a plurality of standard test tube racks holding test tubes.

### BACKGROUND

In recent years automated capping and decapping of test tubes has become an important field of technology given the increasing use of standardized size and formats of test tubes for use e.g., in biology and microbiology. In these fields, often very large numbers of test tubes must be decapped and capped for sample examination, e.g., for mass testing in the present COVID-19 pandemic, under conditions where human intervention must be kept at a minimum during automated sample handling for diagnostic safety and reliability, but also for reasons of efficacy and testing speed. However, also for reasons of workplace safety, human capper-decapper operations should be minimized, as the repeated capping and decapping operation, in particular where this operation involves a rotational movement for screwing and unscrewing threaded test tube caps, can, when repeated often, lead to tendonitis in the persons performing the capping and decapping of such threaded test tube caps. Hence, automation has become a necessity.

A particular important step towards increasing the use of automated capper-decapper devices has been the introduction of standardization within the field of test tubes and within the field of standardized racks for holding standardized test tubes. Today, the dominating standard for racks for biological and microbiological test tubes is the so-called SBS format racks in accordance with ANSI standard ANSI SLAS x-2004, wherein x=1, 2, . . . 6. Such SBS racks may contain, for example 96 test tubes in an array of 8 by 12 apertures designed to hold the tubes securely, but also arrays of 4×6, 8×6 are in common use. The advantage for automation is that the test tube positions are predetermined by the standard and automation equipment can rely on these predetermined positions within manufacturing tolerance.

Test tubes suitable for being stored on SBS format racks are numerous, and particular problems arise for each test tube type when considering automated capping and decapping operations. However, screw cap type and click-on cap type test tubes are predominant. The present invention relates to the field of automated capping and decapping of screw cap type test tubes for storing on a standardized test tube rack, such as e.g., an SBS format test tube rack.

Within the field of capping and decapping test tubes, preferably screw cap test tubes, a problem repeatedly encountered is that existing screw cap test tube capper-decapper devices, such as e.g., the screw cap test tube capper-decapper device detailed in WO 2014020386, are not versatile with respect to the number of test tubes that the capping and decapping devices of the prior art can handle. Rather, these are locked to a predetermined rack format defined by the number of apertures, such as e.g., 8×12, of a particular rack to which the test tube capping and decapping devices of the prior art presents an equal number (here 8×12) of test tube cap grippers for performing capping and decapping on test tubes arranged in the apertures of the predetermined rack format.

The present disclosure is directed to providing inventive solutions to the general problem of increasing the versatility of test tube capping-decapping devices of the prior art, for allowing the test tube capping-decapping devices according to the present disclosure to be useable for capping and decapping of test tubes stored on a larger variety of test tube racks, than merely one, single, pre-set test tube rack. Nevertheless, in the present invention, dimensions are particularly and preferably in accordance with SBS-type test tube rack standards.

The present disclosure discusses the inventive solutions to the abovementioned general problem in the context of SBS format test tube racks, but the skilled person will realize that the teaching of the present disclosure is not limited thereto, as will be discussed herein below in more detail.

### SUMMARY OF THE INVENTION

The present disclosure and invention relates in a first aspect to an arrangement (2) for switching an array of cap grippers (20) comprising at least three cap grippers (4a-c) between a one-dimensional array of cap grippers (20a) and a two-dimensional array of cap grippers (20b); said arrangement (2) comprising said array of cap grippers (20) arranged on a fixture (21) where, on said fixture (21), at least a first cap gripper (4a) of said at least three cap grippers (4a-c) is displaceable arranged; said arrangement (2) further comprising a switch (22) arranged at least for acting on said first cap gripper (4a) when said switch (22) is operated; wherein said fixture (21) defines a plane of cap gripper displacement (214) with respect to an axis of cap engagement (45) of said array of cap grippers (20) and where, in said plane of cap gripper displacement (214), at least said first cap gripper (4a) is displaced (p2,p2′) by action of said switch (22) on said first cap gripper (4a) between a respective position (p2) in said one-dimensional array of cap grippers (20a) and a respective position (p2′) in said two-dimensional array of cap grippers (20b) upon operation of said switch (22).

The present disclosure and invention relates in a second aspect to cap socket cartridge (3) comprising: a cap gripper socket part holder (31) comprising at least one socket bearing element (32,33) comprising a plurality of respective socket bearings (32a-h, 33a-h) for rotatable bearing a plurality of respective cap gripper socket parts (47a-h); and a cap ejector (34) displaceable along an axis of cap engagement (45) relative to said cap gripper socket part holder (31) for ejecting respective caps retained on respective cap sockets (42a-h) comprised on respective cap gripper socket parts (47a-h), by engaging said respective caps when said cap ejector (34) is displaced along said axis of cap engagement (45) away from the cap gripper socket part holder (31).

In a preferred embodiment thereof, the cap socket cartridge (3) is for connecting to an arrangement (2) for switching an array of cap grippers (20) comprising at least three cap grippers (4a-c) between a one-dimensional array of cap grippers (20a) and a two-dimensional array of cap grippers (20b).

The present disclosure and invention relates in a third aspect to a test tube capper-decapper device (1) comprising an arrangement (2) for switching an array of cap grippers (20) comprising at least three cap grippers (4a-c) between a one-dimensional array of cap grippers (20a) and a two-dimensional array of cap grippers (20b). In an embodiment thereof, the test tube capper-decapper device (1) comprises an arrangement according to the first aspect, respectively comprises an arrangement according to the first aspect and a cap socket cartridge (3) according to the second aspect of the present disclosure and invention.

### BRIEF DESCRIPTION OF THE DRAWINGS

FIG. 1: Exemplary embodiment of an arrangement according to the invention.

FIG. 2: Exemplary fixture for use in the invention

FIG. 3: Exemplary switch for use in the invention

FIG. 4: Exemplary hinge for use in the invention

FIG. 5: Embodiment of the arrangement comprising mirrored switch parts for use with the invention.

FIG. 6: Exemplary cap gripper for use in the invention.

FIG. 7: Exemplary cap socket cartridge (front-view) for use in the invention.

FIG. 8: Exemplary cap socket cartridge (rear-view) for use in the invention.

FIG. 9: Exemplary hand-held test tube capper-decapper device of the invention.

FIG. 10: Kit of parts

The present figures are detailed with respect to preferred embodiments of the present invention. It is to be understood, that the embodiments shown in the figures are, while preferred, for illustration of the present invention and cannot be construed as being limiting on the present invention. Unless otherwise indicated, the drawings are intended to be read (e.g., cross-hatching, arrangement of parts, proportion, degree, etc.) together with the specification, and are to be considered a portion of the entire written description of this disclosure.

### DETAILED DESCRIPTION

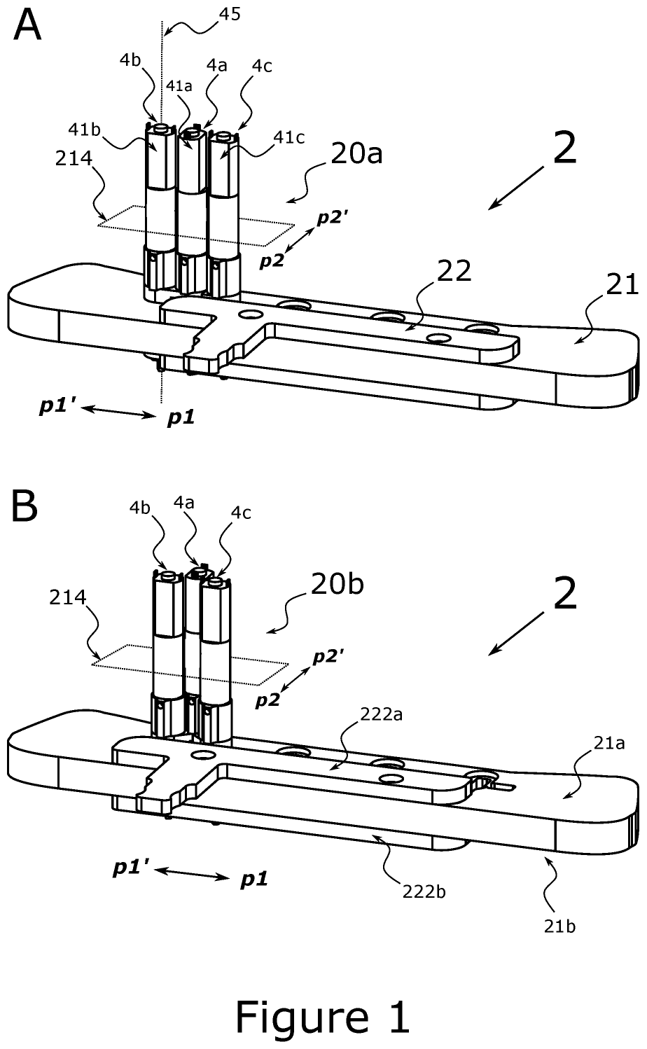

The present disclosure and invention relate in one aspect (c.f. e.g. FIG. 1) to an arrangement (2) for switching an array of cap grippers (20) comprising at least three cap grippers (4a-c) between a one-dimensional array of cap grippers (20a) and a two-dimensional array of cap grippers (20b); said arrangement (2) comprising said array of cap grippers (20) arranged on a fixture (21) where, on said fixture (21), at least a first cap gripper (4a) of said at least three cap grippers (4a-c) is displaceable arranged; said arrangement (2) further comprising a switch (22) arranged at least for acting on said first cap gripper (4a) when said switch (22) is operated; wherein said fixture (21) defines a plane of cap gripper displacement (214) with respect to an axis of cap engagement (45) of said array of cap grippers (20) and where, in said plane of cap gripper displacement (214), at least said first cap gripper (4a) is displaced (p2,p2′) by action of said switch (22) on said first cap gripper (4a) between a respective position (p2) in said one-dimensional array of cap grippers (20a) and a respective position (p2′) in said two-dimensional array of cap grippers (20b) upon operation of said switch (22). Preferably, the cap grippers are screw cap grippers for engaging a screw cap on a test tube comprising a screw cap. The present inventors build their inventions disclosed herein on the basic observation, that in standardized test tube racks, such as e.g., SBS-format test tube racks, the apertures in the racks for holding the test tubes are arranged in simple geometries of linear one-dimensional rows and columns, e.g., of 8 columns and 12 rows of apertures for holding tubes, wherein the aperture centers are equidistantly spaced.

From this, the present inventors have inventively realized, that the versatility of a test tube capper-decapper device comprising a plurality of cap grippers arranged in a one-dimensional array and dedicated to operating on e.g., test tubes arranged in 12 apertures aligned one-dimensionally in a single row, e.g., within one of 8 columns of a 8×12 SBS test tube rack, can be increased to address also test tubes held in 8 apertures aligned one-dimensionally in a single column of the 12 rows of the same 8×12 SBS test tube rack; by shifting the number of cap grippers, that are no longer intended for interaction with a test tube held in the test tube rack, out of the aforementioned one-dimensional array of cap grippers and thereby reducing the number of test tube cap grippers available for engaging a cap of a test tube, without reducing the number of test tube cap grippers present in the capper-decapper device of the invention. Accordingly, in a particularly preferred embodiment of the present invention, structural dimensions of the arrangement (2) permit compliance with ANSI standard ANSI SLAS x-2004, wherein x=1, 2, . . . 6.

In an embodiment thereof, there is further detailed an arrangement of the present invention also allowing for adaptation to a lower number of rack apertures with a higher aperture center spacing. This is the preferred use of the arrangements (2) of the present invention as detailed herein below.

In accordance with the first aspect of the present disclosure and invention, the underlying concept of the arrangement disclosed herein, is that when a switch (22) is operated, wherein the switch (22) is arranged to engage at least a first cap gripper (4a) of at least three cap grippers (4a-c) held in the arrangement (2) of the invention, then a subgroup (24a) of respective cap grippers (4a-c) comprising at least the first cap gripper (4a) is switched from a respective first position (p2) in the one-dimensional array of cap grippers to a respective second position (p2′) outside the one-dimensional array of cap grippers (20a). By the action of the switch (22), a two-dimensional array of cap grippers (20b) is thereby formed.

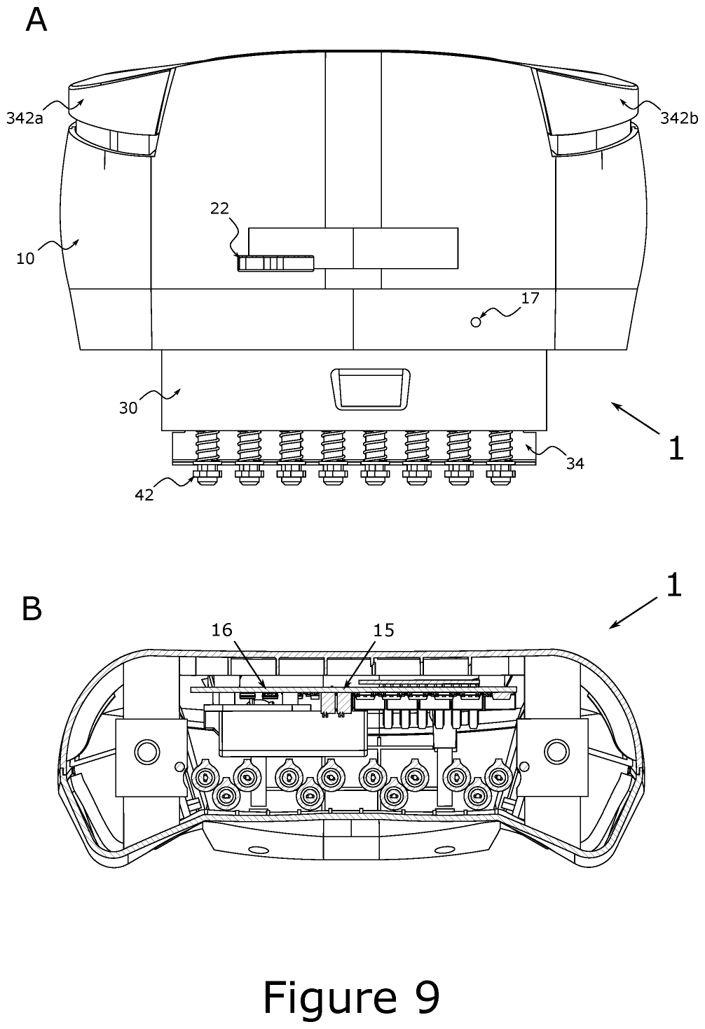

If e.g., as detailed in the above example of an 8×12 SBS test tube rack, a switch is desired between a configuration where a test tube capper-decapper device (1) (c.f. e.g., FIG. 9) comprising the arrangement (2) of the present invention is aligned to engage 12 test tubes, when any comprised cap gripper (4a-c) is aligned in a one-dimensional array (20a), and a configuration where the same test tube capper-decapper device (1) is aligned to engage only 4 or 8 test tubes, the switch (22) does not need to engage more than 4 cap grippers (4a-c) comprised in the arrangement (2) of the present invention, for achieving the requisite desired re-alignment of the cap grippers (4a-c) comprised in the test tube capper-decapper device (1) comprising the arrangement of the present invention (2). A switch from 12 to 6 engaging cap grippers requires, however, re-alignment of 6 cap grippers from the original one-dimensional array (20a) of cap grippers. If, in other configurations, a rearrangement of 8 cap grippers aligned in a one-dimensional array (20a) in the arrangement (2) for engaging test tubes held in an 8×6 SBS test tube rack of the invention to engaging only 6 cap grippers, this would require displacement of only 2 cap grippers for forming the aforementioned two-dimensional array (20b) of cap grippers (4a-c). Hence, by the present arrangement (2) a minimized rearrangement of cap grippers (4a-c) comprised in the original one-dimensional array (20a) can be achieved for adapting to a different, but smaller number of engaging cap grippers.

Accordingly in an embodiment, there is herein detailed an arrangement (2) for switching an array of cap grippers (20) comprising at least three cap grippers (4a-c) between a one-dimensional array of cap grippers (20a) and a two-dimensional array of cap grippers (20b), wherein the arrangement (2) for switching an array of cap grippers (20) is arranged for being comprised within a test tube capper-decapper device (1), preferably a handheld test tube capper-decapper device (1).

In preferred embodiments, the action of the switch (22) is reversible, and an operation of the switch (2s) will also permit a two-dimensional array (20b) of cap grippers (4a-c) of the present arrangement (2) to align as a one-dimensional array (20a) of cap grippers (4a-c) of the present arrangement (2).

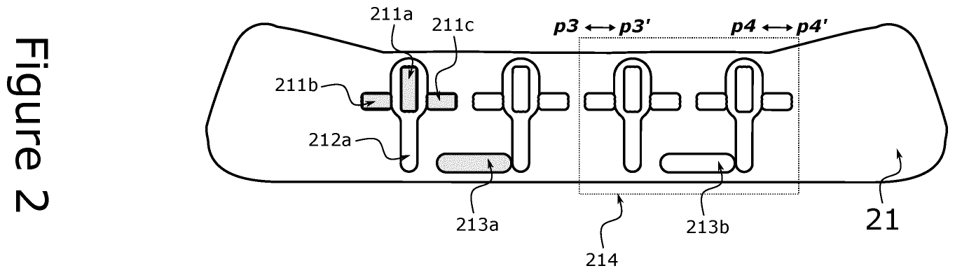

In an embodiment of the arrangement (2) (c.f. FIG. 2), there is herein detailed an arrangement (2) for switching an array of cap grippers (20) comprising at least three cap grippers (4a-c) between a one-dimensional array of cap grippers (20a) and a two-dimensional array of cap grippers (20b), wherein the fixture (21) comprises at least a first cap gripper displacement guide (211a) for guiding, upon operation of the switch (22), the aforementioned first cap gripper (4a) between the respective position (p2) in the one-dimensional array of cap grippers (20a) and the respective position (p2′) in the two-dimensional array of cap grippers (20b). In a preferred embodiment, the first cap gripper displacement guide (211a) is arranged coplanar to the aforementioned plane of cap gripper displacement (214) in the fixture (21).

By providing a displacement guide (211a) for the aforementioned first cap gripper (4a), the present inventors have observed that the operation of the aforementioned switch (22) and alignment of the aforementioned first cap gripper (4a) within the two-dimensional array (20b) is improved. In principle, the displacement guide (211a) can be arranged to guide the aforementioned first cap gripper (4a) for having not just a component of displacement in the aforementioned plane of cap gripper displacement (214), but also to have a component of displacement in parallel to the aforementioned axis of cap engagement (45), as will be discussed below. But it is preferred that the first cap gripper displacement guide (211a) is arranged coplanar to the aforementioned plane of cap gripper displacement (214) in the fixture (21).

A problem of the arrangements (2) detailed herein above is, that while the number of engaging cap grippers remaining in the one-dimensional array (20a) for engaging a test tube held in a rack comprising fewer rack apertures in a particular row or column are adequately reduced; the remaining second and third cap grippers (4b, c) may not necessarily be aligned with the desired rack apertures as yet. Hence, it is preferable that also the second and, optionally, third cap grippers (4b, c) are displaceable within the aforementioned fixture (21) for realignment of these cap grippers as well. Accordingly, in a preferred embodiment of the present arrangement (2) there is herein detailed (c.f. FIG. 2), an arrangement (2) for switching an array of cap grippers (20) comprising at least three cap grippers (4a-c) between a one-dimensional array of cap grippers (20a) and a two-dimensional array of cap grippers (20b), wherein the fixture comprises at least a second cap gripper displacement guide (211b, 211c) arranged coplanar in the fixture (21) to the plane of cap gripper displacement (214) for guiding upon operation of the switch (22) at least a second cap gripper (4b, 4c) of the at least three cap grippers (4a-c) between a respective first position (p3) in the one-dimensional array of cap grippers (20a) and a respective second position (p3′) in the one-dimensional array of cap grippers (20a).

Accordingly, in a further preferred embodiment of the present arrangement (2) there is herein detailed (c.f. FIG. 2), an arrangement (2) for switching an array of cap grippers (20) comprising at least three cap grippers (4a-c) between a one-dimensional array of cap grippers (20a) and a two-dimensional array of cap grippers (20b) wherein the fixture (21) comprises at least second (211b) and third (211c) cap gripper displacement guides arranged coplanar in the fixture (21) to the plane of cap gripper displacement (214) for guiding upon operation of the switch (22) respective second and third cap grippers (4b, 4c) of the at least three cap grippers (4a-c) between respective first positions (p3,p4) in the one-dimensional array of cap grippers (20a) and respective second positions (p3′,p4′) in the one-dimensional array of cap grippers (20a).

In the exemplary embodiment of the present arrangement (2) and invention shown in FIG. 2, the respective displacement guides (211a-c) are guiding a displacement of the respective first, second and third cap grippers (4a-c) in the plane of the fixture (21) and are further arranged to guide (211a) the first cap gripper (4a) out of a one-dimensional array of cap grippers (20a), and the second and third displacement guides (211b, c) are arranged to permit the aforementioned second and third cap grippers (4b, c) to remain in the aforementioned one-dimensional array of cap grippers (20a) while directing their within displacement the one-dimensional array (20a) to new positions (p3′,p4′). When the displacement guides (211a-c) are arranged like this, the arrangement (2) permits the shift of the cap grippers (4a-c) from originally matching a first plurality of one-dimensionally arranged test tubes apertures of a first equidistant aperture center spacing in a first rack having a predetermined length (1), to matching a lower number of test tubes apertures (in the figure from 12 to 8) of a second equidistant aperture center spacing in a second rack, but with the second rack having essentially the same predetermined length (1) as the first rack. This is a consequence of the orthogonal arrangement of the first displacement guide (211a) to the second and third displacement guides (211b, c) in the aforementioned fixture (21).

The skilled person will realize that when the arrangement of the first, second and third displacement guides (211a-c) in the aforementioned fixture (21) are not orthogonal with respect to each other, the arrangement (2) of the invention becomes suitable for rearranging the comprised cap grippers (4a-c) also for two test tube racks, where the predetermined length (1) of each test tube rack are not essentially the same.

Likewise, the skilled person will realize in accordance with general geometric principles, that varying one or more of the lengths of displacement (p2-p2′,p3-p3′,p4-p4′) of the aforementioned cap grippers (4a-c) is suitable for adapting the resulting positions of the aforementioned cap grippers (4a-c) after displacement between test tube racks of essentially the same or different predetermined lengths (1). E.g., in the embodiment shown in FIG. 2, the length of displacements (p2-p2′,p3-p3′,p4-p4′) are essentially the same for all cap grippers (4a-c), but in other embodiments the length of displacement (p2-p2′) for the first cap gripper (4a) could be different from the length of displacements of the second (p3-p3′) and third (p4-p4′) cap grippers (4b, c). Likewise, in the embodiment shown in FIG. 2, the length of displacement of the second (p3-p3′) and third (p4-p4′) cap grippers (4b, c) are shown to be equal, which is advantageous from a constructional point of view, but is not mandatory. E.g., in the shown embodiment in FIG. 2 of a 12 to 8 reduction of cap grippers, this entails an increase in the equidistant aperture spacing of the second rack compared to the first rack. This increase can be evenly shared between second and third displacement guides (211b, c) as shown in the figure, but can also be unevenly distributed between the two displacement guides (211b, c) in accordance with general principles of geometry.

In a preferred embodiment of the present arrangement (2) there is herein detailed (c.f. FIG. 2), an arrangement (2) for switching an array of cap grippers (20) comprising at least three cap grippers (4a-c) between a one-dimensional array of cap grippers (20a) and a two-dimensional array of cap grippers (20b), wherein the cap gripper displacement guides (211a-c) are throughbores traversing the fixture (21) in parallel to the primary axis of cap engagement (45) of the aforementioned array of cap grippers (20).

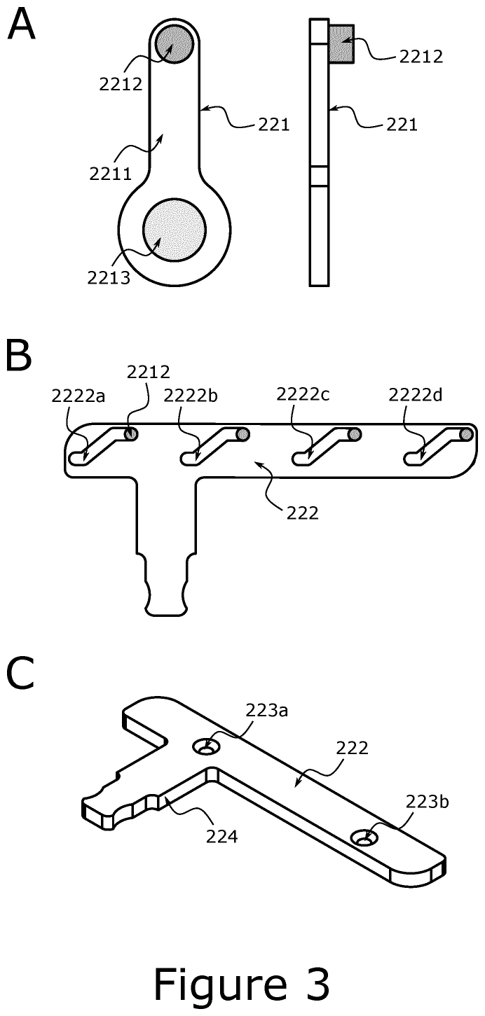

In an embodiment of the present arrangement (2) there is herein detailed (c.f. FIG. 3), an arrangement (2) for switching an array of cap grippers (20) comprising at least three cap grippers (4a-c) between a one-dimensional array of cap grippers (20a) array of cap grippers (20b), wherein the switch (22) comprises a switch body (222) displaceable between a first position (p1) and a second position (p1′) and at least one respective displacer (221) engaged by the switch body (222), the at least one respective displacer (221) acting on a respective first cap gripper (4a) of the at least three cap grippers (4a-c) when the switch (22) is operated, such that the at least one respective displacer (221) transfers a displacement (p1,p1′) of the switch body (222) at least into a displacement (p2,p2′) of the respective first cap gripper (4a). In an embodiment thereof, the displacement (p1,p1′) of the switch body (222) is orthogonal to the displacement (p2, p2′) of the respective first cap gripper (4a). As further discussed below, the advantageous coupling of the switch (22) to the respective first cap gripper (4a) by the respective displacer (221) permits a single switch to operate on a plurality of first cap grippers (4a) by connecting to each first cap gripper (4a) by means of a respective displacer (221) for each respective first cap gripper (4a).

In embodiments thereof (cf. FIGS. 2 and 3), the fixture (21) and the switch body (222) comprise complementary switch body directional displacement guide means (213a, 213b, 223a, 223b) arranged for aligning and directing the displacement (p1, p1′) of the switch body (222) with respect to the fixture (21). In an embodiment thereof, a respective complementary switch body directional displacement guide means of the fixture (21) is a recess or a throughbore (213a, 213b), and a respective complementary switch body directional displacement guide means of said switch body (222) is a pin (223a, 223b).

In embodiments thereof, respective displacer (221) comprises a respective displacer pin (2212) for engaging a respective pin guide recess (2222a-d) comprised in the switch body (222), such that when the switch body (222) is displaced between the positions (p1,p1′), the respective displacer pin (2212) displaces along the respective pin guide recess (2222a-d), thereby transferring the displacement (p1, p1′) of the switch body (222) at least into the aforementioned displacement (p2,p2′) of the aforementioned respective first cap gripper (4a).

In embodiments thereof, a respective displacer (221) comprises an elongated displacer body (2211) where, on the aforementioned elongated displacer body (2211), a respective connector throughbore (2213) is oppositely arranged to a respective displacer pin (2212); this respective connector throughbore (2213) arranged for connecting a respective first cap gripper (4a) to the respective displacer (221) throughgoing in the aforementioned respective connector throughbore (2213).

In embodiments thereof, the fixture (21) comprises at least one respective displacer guide (212a) for guiding a respective displacer (221) said displacement (p2,p2′) when the switch (22) is operated.

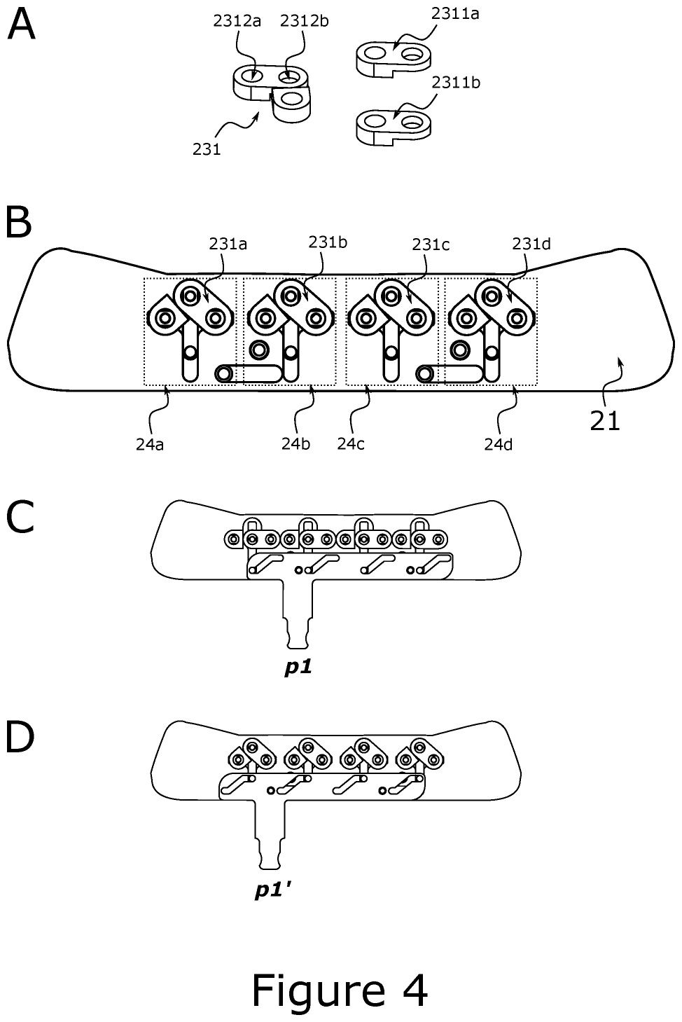

In an embodiment of the present arrangement (2) there is herein detailed (cf. FIG. 4), an arrangement (2) for switching an array of cap grippers (20) comprising at least three cap grippers (4a-c) between a one-dimensional array of cap grippers (20a) and a two-dimensional array of cap grippers (20b) according to the previous embodiments, wherein respective first (4a), second (4b) and third (4c) cap grippers displaceable arranged in respective first (211a), second (211b) and third (211c) cap gripper displacement guides and hingedly connected using a respective hinge unit (231), each respective cap gripper (4a-c) pivoting in the respective hinge unit (231), and wherein the respective first (4a) cap gripper is arranged in a respective connector throughbore (2213) of a respective displacer (221), such that the respective first (4a), second (4b) and third (4c) cap grippers are respectively displaced between respective first positions (p2,p3,p4) in the one-dimensional array of cap grippers (20a) and respective second positions (p2′,p3′,p4′) in the two-dimensional array of cap grippers (20b) by action of the respective displacer (221) on the respective first (4a) cap gripper upon operation of the switch (22). In this manner, a single displacement of the switch (22) can be transferred to all respective cap grippers (4a-c) in the arrangement.

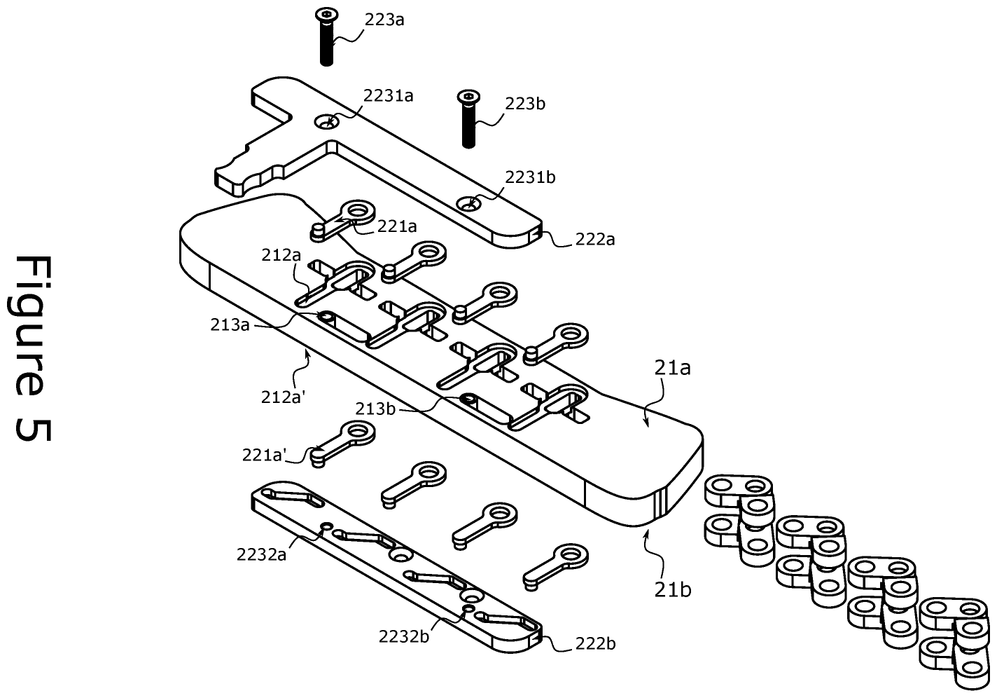

In an embodiment of the present arrangement (2) there is herein detailed (cf. FIG. 5), an arrangement (2) for switching an array of cap grippers (20) comprising at least three cap grippers (4a-c) between a one-dimensional array of Cap grippers (20a) and a two-dimensional array of cap grippers (20b) according to the previous embodiments, wherein the fixture (21) defines a first fixture face (21a) and an opposite second fixture face (21b), each respective fixture face (21a, 21b) arranged in parallel to the plane of cap gripper displacement (214), and where, on the respective opposite fixture faces (21a, 21b), respective mirrored displacer guides (212a, 212a′) are arranged such that respective mirrored displacers (221a, 221a′) each can act on an aforementioned respective first cap gripper (4a) and engage the switch body (222). By mirroring the abovementioned features of the present arrangement around the fixture (21) improved stability and accuracy is obtained, favoring the ability of the present arrangement (2) for inclusion into test tube capper-decapper devices (1) for automated testing.

In an embodiment thereof (cf. FIG. 5), there is herein detailed the arrangement (2), wherein the switch body (222) comprises mirrored first (222a) and second (222b) switch body elements, mirrored arranged with respect to the respective opposite fixture faces (21a, 21b) such that each respective first (222a) and second (222b) switch body element can engage respectively one of the respective mirrored displacers (221a, 221a′) for transferring a displacement (p1,p1′) of the switch body (222) at least into a respective displacement (p2,p2′) of an aforementioned respective first cap gripper (4a).

It is a particular advantage of the present arrangement (2) and invention that the elements detailed herein above are easily additive to the arrangement (2) of the invention, such that e.g., an arrangement (2) of the invention for switching between e.g., an 8×12 test tube rack adaption can be assembled from the same elements as another arrangement (2) according to the invention for switching between e.g., a 4×6 test tube arrangement. The only requirement is that the number of first cap grippers displaced match the difference in number of apertures between the test tube rack having the highest number of apertures and the test tube rack having the smallest number of apertures.

However, and in accordance with the present inventors' focus on finding suitable solutions to the problem of capper-decapper device (1) versatility for capper-decapper devices intended for use with SBS-format racks, there is, in an embodiment of the present arrangement (2) detailed (cf. FIG. 4B), an arrangement (2) for switching an array of cap grippers (20) comprising at least three cap grippers (4a-c) between a one-dimensional array of cap grippers (20a) and a two-dimensional array of cap grippers (20b) according to any of the previous embodiments, wherein respective first (4a), second (4b) and third (4c) cap grippers, arranged in respective first (211a), second (211b), and third (211c) cap gripper displacement guides comprised in the fixture (21) form a respective cap gripper cluster (24a-d) within the arrangement (2), upon which respective cap gripper cluster (24a-d) a respective displacer (221a) can act to transfer a displacement (p1, p1′) of said switch body (222) into respective displacements (p2, p3,p4,p2′,p3′,p4) of said respective first (4a), second (4b), and third (4c) cap grippers. In an embodiment thereof, the arrangement (2) comprises any of two, three or four cap gripper clusters (24a-d). Thereby, full versatility across the SBS-rack format standard can be assured.

In an embodiment of the present arrangement (2) there is herein detailed (cf. FIG. 1), an arrangement (2) for switching an array of cap grippers (20) comprising at least three cap grippers (4a-c) between a one-dimensional array of cap grippers (20a) and a two-dimensional array of cap grippers (20b) according to any preceding embodiment, wherein the switch (22) is a two-way switch, permitting a respective cap gripper (4a-c) of the at least three cap grippers (4a) to switch interchangeably between an aforementioned respective position (p2,p3,p4) of the respective cap gripper (4a-c) in the one-dimensional array of cap grippers (20a) and an aforementioned respective position (p2′,p3′,p4′) in the two-dimensional array of cap drivers (20b) upon operation of the switch (22).

In an embodiment thereof, particularly suitable when the arrangement (2) of the present invention is intended for being comprised in a stationary test tube capper-decapper device (1) with access to a stationary source of (electrical) energy, the switch (22) can be actuated and the test tube capper-decapper (1) comprising the arrangement (2) of the present invention can comprise actuation means, such as e.g., an electromotor or the like. However, when the arrangement (2) of the present invention is intended for being comprised in a handheld test tube capper-decapper device (1) without access to a stationary source of (electrical) energy, the switch (22) preferably comprises a switch grip (224) for permitting a user of the test tube capper-decapper device (1) comprising the arrangement (2) of the present invention to manually operate the aforementioned switch (22), thereby lowering energy requirements on a power source included into the handheld test tube capper-decapper device (1).

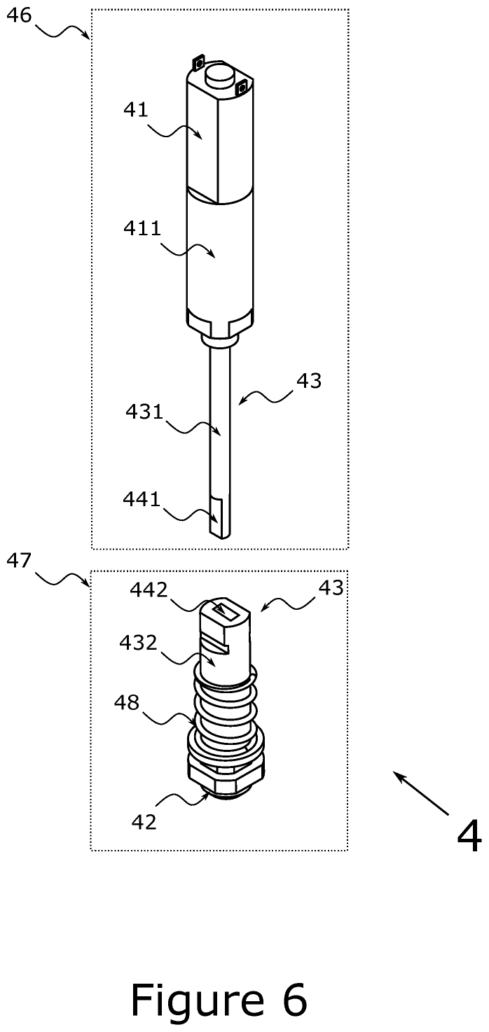

In a particularly preferred embodiment of the present arrangement (2) there is herein detailed (cf. FIGS. 1 and 6), an arrangement (2) for switching an array of cap grippers (20) comprising at least three cap grippers (4a-c) between a one-dimensional array of cap grippers (20a) and a two-dimensional array of cap grippers (20b) according to any preceding embodiment, wherein a respective cap gripper (4a-c) is actuated for individually (41a-c) rotating independently the respective cap gripper (4a-c) in use.

In general, the advantage of using individually actuated cap grippers is well detailed in the prior art. In relation to the present invention, individually actuated cap grippers (4) have significant benefits with respect to providing the desired versatility, as the cap gripper 4 (cf. FIG. 6) can be equipped with an individually attached actuator (41), which then permits displacement of the cap gripper (4) in accordance with the above detailed embodiments without the displacement being restricted beyond the restrictions imposed by any displacement guides.

In embodiments of the individually actuated cap gripper (4), a respective cap gripper (4a-c) comprises a cap socket (42), a cap gripper pin (43), and a cap gripper actuator (41) comprising an electro motor (411) engaging the cap gripper pin (43); the cap gripper pin (43) connecting the cap gripper actuator (41) to the cap socket (42) for transferring a rotation of the electro motor (411) to a rotation of the cap socket (42). In the preferred embodiment shown in FIG. 6, the cap gripper pin (43) has been separated into two parts, an actuator pin (431) and a socket pin (432) as further discussed below.

In embodiments (cf. FIG. 6) of the above detailed cap gripper (4), particularly the above detailed individually actuated cap gripper (4), there is herein detailed in a particularly preferred embodiment, an arrangement (2) for switching an array of cap grippers (20) comprising at least three cap grippers (4a-c) between a one-dimensional array of cap grippers (20a) and a two-dimensional array of cap grippers (20b) according to any previous embodiment, wherein a respective cap gripper (4) comprises: a cap gripper actuation part (46) comprising an actuator pin (431) and a cap gripper actuator (41) comprising an electro motor (411), said actuator pin (431) rotatable by said electro motor (411); and a cap gripper socket part (47) comprising a socket pin (432) connecting to a cap socket (42); the actuator pin (431) and the socket pin (432) respectively comprising a complementary connecting means (441, 442) for releasably connecting the actuator pin (431) and the socket pin (432), thereby forming the cap gripper (4) from the cap gripper actuation part (46) and the cap gripper socket part (47) when connected.

When a cap gripper (4) as detailed above and comprising an actuator pin (431) and a socket pin (432) respectively comprising a complementary connecting means (441,442) for releasably connecting the actuator pin (431) and the socket pin (432), thereby forming the cap gripper (4) from the cap gripper actuation part (46) and the cap gripper socket part (47) when connected; is used as a cap gripper (4a-c) in the arrangements (2) of the present invention, an unintended complication from displacing the aforementioned first cap grippers (4a) from their original positions in the one-dimensional array is resolved, namely that the displaced cap grippers in principle limits access for a test tube capper-decapper device (1) comprising an arrangement (2) of the present invention from some types of screw caps and test tubes held in racks having two neighboring rows or columns of test tube apertures due to geometric restrictions.

The above disclosed cap grippers (4) solve this problem by having a part of the displaced first cap grippers (4a) comprising a removable part (e.g., the cap gripper socket part (47)) which then, after removal, no longer geometrically restrict the test tube capper-decapper device (1) comprising an arrangement (2) of the present invention.

Suitable complementary connecting means (441,442) for releasably connecting the actuator pin (431) and the socket pin (432) are well known to the skilled person, e.g., click-locks, screw-lock connections etc., and are not further detailed in the present invention and disclosure.

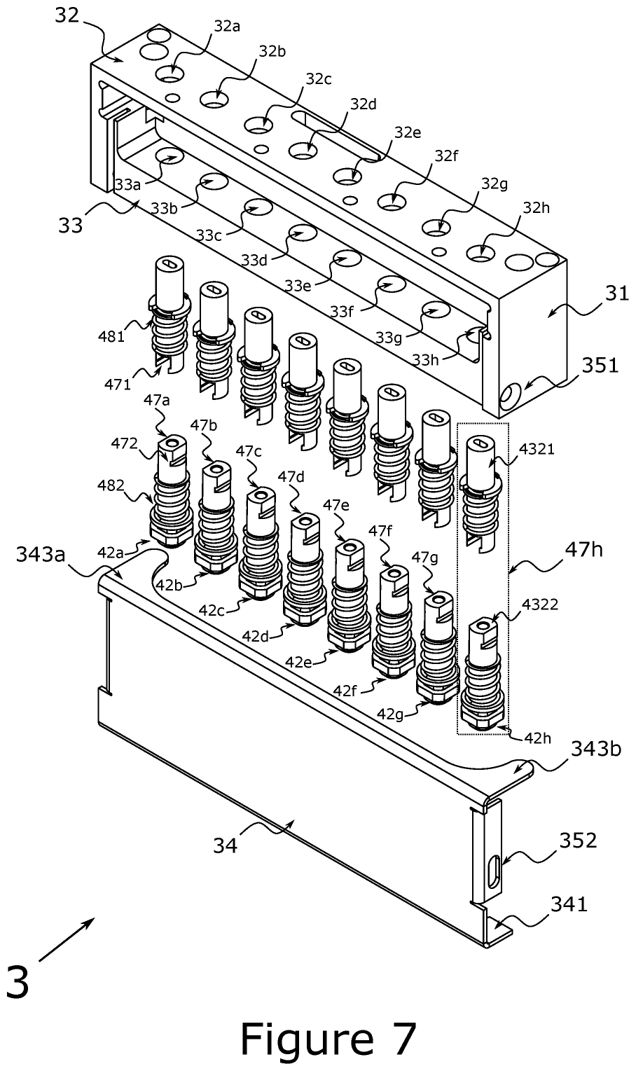

In a preferred embodiment of the invention, complementary connection means (441, 442) comprise opposing hinge elements (471, 472) as detailed herein below (cf. FIG. 7). A particularly preferred complementary connection means (441, 442) comprises a mortise and tenon joint (or tap and hole joint), with one pin (431, 432) presenting the mortise (442) and the opposite pin (431, 432) presenting the tenon (441). In FIGS. 6 and 7, the mortise (442) is arranged on the socket pin (432) and the tenon (441) on the actuator pin (431), but the reverse is equally suitable.

In embodiments of the above detailed cap gripper (4) (cf. FIG. 6) and arrangement (2), the cap gripper socket part (47) further comprises biasing means (48) for biasing an alignment of the socket pin (432) and the cap socket (42) with respect to the axis of cap engagement (45).

In embodiments of the above detailed cap gripper (4) (cf. FIG. 6) and arrangement (2), the cap gripper socket part (47) comprises a first socket pin part (4321) and a second socket pin part (4322) hingedly connectable by complementary slide connector means (471,472).

In embodiments of the above detailed cap gripper (4) (cf. FIG. 6) and arrangement (2), the first socket pin part (4321) and the second socket pin part (4321) are individually biased (481, 482) with respect to the aforementioned axis of cap engagement (45).

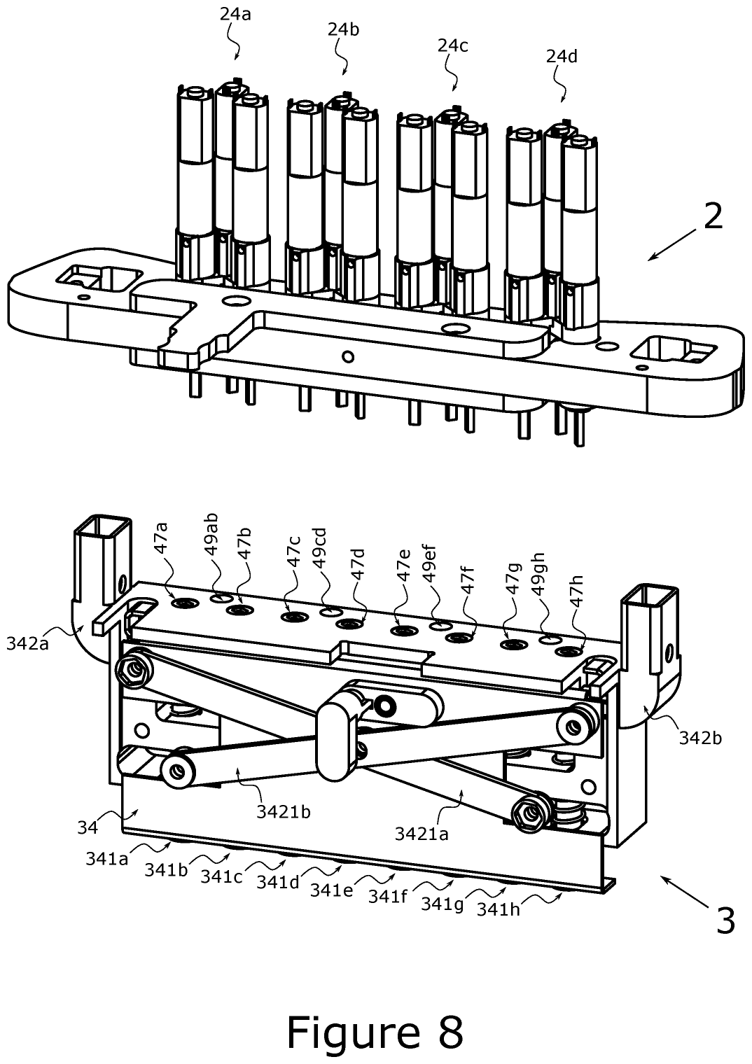

In embodiments of the above detailed cap gripper (4), particularly the above detailed individually actuated cap gripper (4), there is herein detailed in a particularly preferred embodiment, an arrangement (2) for switching an array of cap grippers (20) comprising at least three cap grippers (4a-c) between a one-dimensional array of cap grippers (20a) and a two-dimensional array of cap grippers (20b), wherein an aforementioned cap gripper socket part (47) is rotatable comprised within a cap socket cartridge (3). Suitable cap socket cartridges (3) for use with the present arrangement (2) and present cap gripper (4) are detailed herein below (cf. FIGS. 7 and 8).

In an aspect and embodiment of the present invention, there is herein detailed a cap socket cartridge (3) comprising:
a cap gripper socket part holder (31) comprising at least one socket bearing element (32,33) comprising a plurality of respective socket bearings (32a-h, 33a-h) for rotatable bearing a plurality of respective cap gripper socket parts (47a-h); and
a cap ejector (34) displaceable along an axis of cap engagement (45) relative to said cap gripper socket part holder (31) for ejecting respective caps retained on respective cap sockets s (42a-h) comprised on respective cap gripper socket parts (47a-h), by engaging said respective caps when said cap ejector (34) is displaced along said axis of cap engagement (45) away from said cap gripper socket part holder (31).

In the preferred embodiment thereof, the cap socket cartridge (3) is for connecting to an arrangement (2) for switching an array of cap grippers (20) comprising at least three cap grippers (4a-c) between a one-dimensional array of cap grippers (20a) and a two-dimensional array of cap grippers (20b). In the below discussion, the cap socket cartridge (3) of the present invention is discussed in light of this particularly preferred embodiment.

In an embodiment of the cap socket cartridge (3) there is herein detailed, a cap socket cartridge (3) for connecting to an arrangement (2) for switching an array of cap grippers (20) comprising at least three cap grippers (4a-c) between a one-dimensional array of cap grippers (20a) and a two-dimensional array of cap grippers (20b), wherein said arrangement (2) is according to any of the embodiments of the arrangement detailed herein.

In an embodiment thereof, the cap socket cartridge (3) is arranged for being operative after attachment to a handheld test tube capper-decapper device (1).

In a preferred embodiment of the cap socket cartridge (3), the cap ejector (34) is slidingly attached to the cap gripper socket part holder (31). Such sliding arrangements are well known in the art, e.g., in the embodiment shown in FIG. 7, opposing throughbores (351, 352) for receiving a sliding peg is used, wherein one of the throughbores (here on the cap ejector (34)) is elongated and the throughbore on the cap socket cartridge (3) is for holding such a sliding peg.

In an embodiment (cf. FIG. 8) of the cap socket cartridge (3) according to any previous embodiment there is herein detailed, a cap socket cartridge (3) for connecting to an arrangement (2) for switching an array of cap grippers (20) comprising at least three cap grippers (4a-c) between a one-dimensional array of cap grippers (20a) and a two-dimensional array of cap grippers (20b), wherein said socket bearings (32a-h, 33a-h) are throughbores comprised in said at least one socket bearing element (32,33); each respective throughbore arranged for rotatable bearing a respective cap gripper socket part (47a-h) of said plurality of cap gripper socket parts (47a-h).

In an embodiment (cf. FIG. 8) of the cap socket cartridge (3) according to any previous embodiment there is herein detailed, a cap socket cartridge (3) for connecting to an arrangement (2) for switching an array of cap grippers (20) comprising at least three cap grippers (4a-c) between a one-dimensional array of cap grippers (20a) and a two-dimensional array of cap grippers (20b), wherein when said plurality of cap gripper socket parts (47a-h) comprise first and second socket pin parts (4321, 4322), said socket bearing element (32,33) comprises a first socket bearing element (32) for rotatable bearing said first socket pin parts (4321) of said plurality of cap gripper socket parts (47a-h), and a second socket bearing element (33) for rotatable bearing said second socket pin parts (4322) of said plurality of cap gripper socket parts (47a-h).

In an embodiment of the cap socket cartridge (3) according to any previous embodiment there is herein detailed, a cap socket cartridge (3) for connecting to an arrangement (2) for switching an array of cap grippers (20) comprising at least three cap grippers (4a-c) between a one-dimensional array of cap grippers (20a) and a two-dimensional array of cap grippers (20b), wherein said cap ejector (34) comprises a cap ejector plate (341), for ejecting said respective caps from said respective cap sockets (42a-h) when said cap ejector (34) is displaced along said axis of cap engagement (45) away from said cap gripper socket part holder (31).

In an embodiment of thereof (cf. FIG. 8), there is herein detailed, a cap socket cartridge (3) for connecting to an arrangement (2) for switching an array of cap grippers (20) comprising at least three cap grippers (4a-c) between a one-dimensional array of cap grippers (20a) and a two-dimensional array of cap grippers (20b), wherein said cap ejector plate (341) comprises a plurality of throughbores (341a-h) matching said plurality of cap gripper socket parts (47a-h) in number, said plurality of cap gripper socket parts (47a-h) throughgoing arranged therein, such that said cap ejector plate (341) can engage respective caps retained on respective cap sockets (42a-h) comprised on said plurality of cap gripper socket parts (47a-h), and eject said respective caps from said respective cap sockets (42a-h), when said cap ejector (34) is displaced along said axis of cap engagement (45) away from said cap gripper socket part holder (31).

In an embodiment of the cap socket cartridge (3) according to any previous embodiment there is herein detailed, a cap socket cartridge (3) for connecting to an arrangement (2) for switching an array of cap grippers (20) comprising at least three cap grippers (4a-c) between a one-dimensional array of cap grippers (20a) and a two-dimensional array of cap grippers (20b), wherein at least one cap ejector displacer (342a, 342b) engages said cap ejector (34) for permitting a user to displace said cap ejector (34) by displacing at said least one cap ejector displacer (342a, 342b). In an embodiment thereof, the said cap ejector (34) comprises at least one ejector surface (343a, b) permitting said at least one cap ejector displacer (342a, 342b) to engage said cap ejector (34) for displacing said cap ejector (34) away from said cap socket cartridge (3).

In an embodiment of the cap socket cartridge (3) thereof there is herein detailed, a cap socket cartridge (3) for connecting to an arrangement (2) for switching an array of cap grippers (20) comprising at least three cap grippers (4a-c) between a one-dimensional array of cap grippers (20a) and a two-dimensional array of cap grippers (20b), wherein said at least one cap ejector displacer (342a, 342b) comprises a biased section (3421a, 3421b) for restricting a displacement of said ejector displacer (342a, 342b) to a displacement between a first position not engaging respective caps retained on respective cap sockets (42a-h) and a second position ejecting said respective caps from said respective cap sockets (42a-h), and for subsequently returning said at least one cap ejector displacer (342a, 342b) to said first position from said second position.

In an embodiment (not shown) of the cap socket cartridge (3) according to any previous embodiment there is herein detailed, a cap socket cartridge (3) for connecting to an arrangement (2) for switching an array of cap grippers (20) comprising at least three cap grippers (4a-c) between a one-dimensional array of cap grippers (20a) and a two-dimensional array of cap grippers (20b), wherein said cap ejector (34) is actuated.

In an embodiment (cf. FIG. 8) of the cap socket cartridge (3) according to any previous embodiment there is herein detailed, a cap socket cartridge (3) for connecting to an arrangement (2) for switching an array of cap grippers (20) comprising at least three cap grippers (4a-c) between a one-dimensional array of cap grippers (20a) and a two-dimensional array of cap grippers (20b), wherein said cap gripper socket part holder (31) comprises a plurality of respective receptacles (49ab, 49cd, 49ef, 49gh) arranged in said cap gripper socket part holder (31) for receiving, but not engaging, respective cap gripper actuation parts (46) of respective first cap grippers (4a) comprised in said arrangement (2), when said respective first cap grippers (4a) are aligned in said two-dimensional array of cap grippers (20b).

In an embodiment of the cap socket cartridge (3) according to any previous embodiment there is herein detailed, a cap socket cartridge (3) for connecting to an arrangement (2) for switching an array of cap grippers (20) comprising at least three cap grippers (4a-c) between a one-dimensional array of cap grippers (20a) and a two-dimensional array of cap grippers (20b), wherein said cap gripper socket part holder (31) comprises, for every two cap gripper socket parts (47a, b), (47c, d), (47e, f), (47g,h) rotatable arranged therein, a respective receptacle (49ab, 49cd, 49ef, 49gh) for receiving, but not engaging, a cap gripper actuation part (46) of a respective first cap gripper (4a) comprised in said arrangement (2), when said respective first cap gripper (4a) is aligned in said two-dimensional array of cap grippers (20b).

In an embodiment of the cap socket cartridge (3) according to any previous embodiment there is herein detailed, a cap socket cartridge (3) for connecting to an arrangement (2) for switching an array of cap grippers (20) comprising at least three cap grippers (4a-c) between a one-dimensional array of cap grippers (20a) and a two-dimensional array of cap grippers (20b), wherein said cap gripper socket part holder (31) is arranged within a cap socket cartridge housing (30).

In a further aspect of the present invention (cf. FIG. 9) there is herein detailed a test tube capper-decapper device (1) comprising an arrangement (2) for switching an array of cap grippers (20) comprising at least three cap grippers (4a-c) between a one-dimensional array of cap grippers (20a) and a two-dimensional array of cap grippers (20b).

In an embodiment thereof, there is detailed a test tube capper-decapper device (1), wherein said test tube capper-decapper device is a handheld test tube capper-decapper device (1).

In an embodiment thereof, there is detailed a test tube capper-decapper device (1) according to any previous embodiment, wherein said arrangement (2) for switching an array of cap grippers (20) comprising at least three cap grippers (4a-c) between a one-dimensional array of cap grippers (20a) and a two-dimensional array of cap grippers (20b) is an arrangement (2a) according to any embodiment detailed herein.

In an embodiment thereof, there is detailed a test tube capper-decapper device (1) according to any previous embodiment, a test tube capper-decapper device (1) comprising an arrangement (2) for switching an array of cap grippers (20) comprising at least three cap grippers (4a-c) between a one-dimensional array of cap grippers (20a) and a two-dimensional array of cap grippers (20b) according any embodiment detailed thereof; and a cap socket cartridge (3) according to any embodiment detailed thereof.

In an embodiment thereof, there is detailed a test tube capper-decapper device (1) according to any previous embodiment, a test tube capper-decapper device (1), wherein said cap socket cartridge (3) is exchangeable.

In an embodiment thereof, there is detailed a test tube capper-decapper device (1) according to any previous embodiment, a test tube capper-decapper device (1) wherein said arrangement (2) for switching an array of cap grippers (20) comprising at least three cap grippers (4a-c) between a one-dimensional array of cap grippers (20a) and a two-dimensional array of cap grippers (20b) is arranged within a device housing (10).

In an embodiment thereof, there is detailed a test tube capper-decapper device (1) according to any previous embodiment, a test tube capper-decapper device (1) further comprising a controller (15) comprising a programmable unit for controlling at least one actuation of at least one actuatable unit (22, 34,4, 41,46) comprised in said test tube capper-decapper device (1).

In an embodiment thereof, there is detailed a test tube capper-decapper device (1) according to any previous embodiment, the test tube capper-decapper device (1) is adapted for being connected to an external power supply (16). In an embodiment thereof, the test tube capper-decapper device (1) of the invention comprises an internal power supply, such as e.g., an internal battery, arranged for being connected to said external power supply and storing energy therefrom, and an indicator (17) for indicating a level of internal power supply.

Accordingly, in a preferred embodiment, the test tube capper-decapper device (1) according to any of the embodiments herein comprises a socket (16) and cording for connecting to an external power supply. In an embodiment thereof, the test tube capper-decapper device (1) comprises an internal power supply arranged for being connected to said external power supply via said socket (16) and cording and storing energy therefrom, and an indicator (17) for indicating a level of internal power supply.

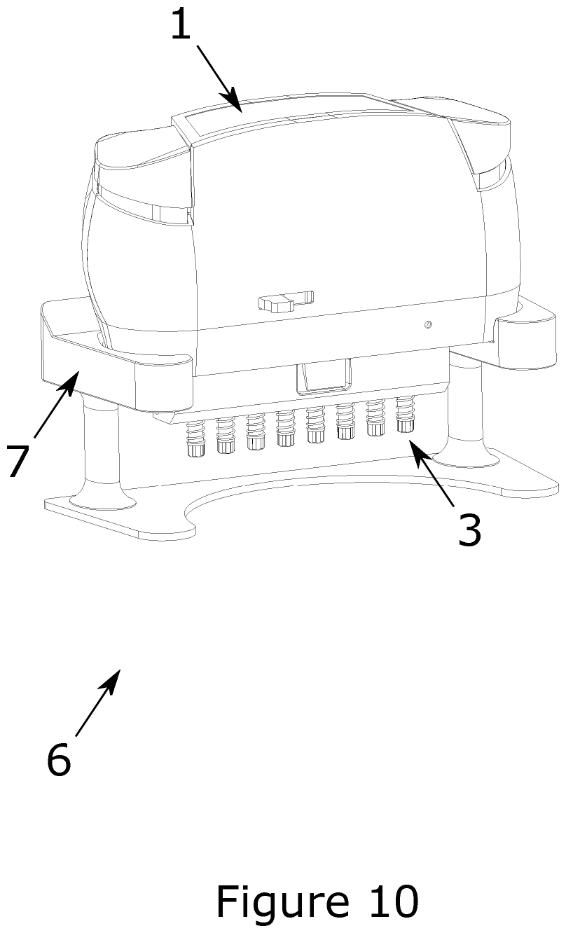

In a further aspect of the present invention (cf. FIG. 10) there is herein detailed a kit of parts (6) comprising at least a test tube capper-decapper device (1) comprising an arrangement (2) for switching an array of cap grippers (20) comprising at least three cap grippers (4a-c) between a one-dimensional array of cap grippers (20a) and a two-dimensional array of cap grippers (20b) according to any embodiment thereof disclosed herein, and further at least one a cap socket cartridge (3) according to any embodiment thereof disclosed herein.

In an embodiment thereof, the kit of parts (6) further comprises a stand (7) for said test tube capper-decapper device (1).

### CLOSING COMMENTS

Although the present invention has been described in detail for purpose of illustration, it is understood that such detail is solely for that purpose, and variations can be made therein by those skilled in the art in practicing the claimed subject matter, from a study of the drawings, the disclosure, and the appended claims.

The term “comprising” as used in the claims does not exclude other elements or steps. The indefinite article “a” or “an” as used in the claims does not exclude a plurality. A single processor or other unit may fulfill the functions of several means recited in the claims. A reference sign used in a claim shall not be construed as limiting the scope.

1-52. (canceled)

53. An arrangement for switching an array of cap grippers comprising at least three cap grippers between a one-dimensional array of cap grippers and a two-dimensional array of cap grippers; said arrangement comprising said array of cap grippers arranged on a fixture where, on said fixture, at least a first cap gripper of said at least three cap grippers is displaceable arranged; said arrangement further comprising a switch arranged at least for acting on said first cap gripper when said switch is operated; wherein said fixture defines a plane of cap gripper displacement with respect to an axis of cap engagement of said array of cap grippers and where, in said plane of cap gripper displacement, at least said first cap gripper is displaced by action of said switch on said first cap gripper between a respective position in said one-dimensional array of cap grippers and a respective position in said two-dimensional array of cap grippers upon operation of said switch.

54. The arrangement for switching an array of cap grippers comprising at least three cap grippers between a one-dimensional array of cap grippers and a two-dimensional array of cap grippers according to claim 53, wherein said arrangement for switching an array of cap grippers is arranged for being comprised within a test tube capper-decapper device.

55. The arrangement for switching an array of cap grippers comprising at least three cap grippers between a one-dimensional array of cap grippers and a two-dimensional array of cap grippers according to claim 53, wherein said fixture comprises at least a first cap gripper displacement guide arranged coplanar to said plane of cap gripper displacement for guiding, upon operation of said switch, said first cap gripper between said respective position in said one-dimensional array of cap grippers and said respective position in said two-dimensional array of cap grippers.

56. The arrangement for switching an array of cap grippers comprising at least three cap grippers between a one-dimensional array of cap grippers and a two-dimensional array of cap grippers according to claim 53, wherein said fixture comprises at least a second cap gripper displacement guide arranged coplanar in said fixture to said plane of cap gripper displacement for guiding upon operation of said switch at least a second cap gripper of said at least three cap grippers between a respective first position in said one-dimensional array of cap grippers and a respective second position in said one-dimensional array of cap grippers.

57. The arrangement for switching an array of cap grippers comprising at least three cap grippers between a one-dimensional array of cap grippers and a two-dimensional array of cap grippers according to claim 53, wherein said switch comprises a switch body displaceable between a first position and a second position and at least one respective displacer engaged by the switch body, said at least one respective displacer acting on a respective first cap gripper of said at least three cap grippers when said switch is operated, such that said at least one respective displacer transfers a displacement of said switch body at least into a displacement of said respective first cap gripper.

58. The arrangement for switching an array of cap grippers comprising at least three cap grippers between a one-dimensional array of cap grippers and a two-dimensional array of cap grippers according to claim 57, wherein a said respective displacer comprises a respective displacer pin for engaging a respective pin guide recess comprised in said switch body, such that when said switch body is displaced between said positions, said respective displacer pin displaces along said respective pin guide recess, thereby transferring said displacement of said switch body at least into said displacement of said respective first cap gripper.

59. The arrangement for switching an array of cap grippers comprising at least three cap grippers between a one-dimensional array of cap grippers and a two-dimensional array of cap grippers according to claim 57, wherein respective first, second and third cap grippers are displaceable arranged in respective first, second and third cap gripper displacement guides and hingedly connected using a respective hinge unit, each respective cap gripper pivoting in said respective hinge unit, and wherein said respective first cap gripper is arranged in a respective connector throughbore of a respective displacer, such that said respective first, second and third cap grippers are respectively displaced between respective first positions in said one-dimensional array of cap grippers and respective second positions in said two-dimensional array of cap grippers by action of said respective displacer on said respective first cap gripper upon operation of said switch.

60. The arrangement for switching an array of cap grippers comprising at least three cap grippers between a one-dimensional array of cap grippers and a two-dimensional array of cap grippers according to claim 57, wherein said fixture defines a first fixture face and an opposite second fixture face, each respective fixture face arranged in parallel to said plane of cap gripper displacement, and where, on said respective opposite fixture faces, respective mirrored displacer guides are arranged such that respective mirrored displacers each can act on a said respective first cap gripper and engage said switch body.

61. The arrangement for switching an array of cap grippers comprising at least three cap grippers between a one-dimensional array of cap grippers and a two-dimensional array of cap grippers according to claim 60, wherein said switch body comprises mirrored first and second switch body elements, mirrored arranged with respect to said respective opposite fixture faces such that each respective first and second switch body element can engage respectively one of said respective mirrored displacers for transferring a displacement of said switch body at least into a respective displacement of a said respective first cap gripper.

62. The arrangement for switching an array of cap grippers comprising at least three cap grippers between a one-dimensional array of cap grippers and a two-dimensional array of cap grippers according to claim 55, wherein respective first, second and third cap grippers, arranged in respective first, second, and third cap gripper displacement guides comprised in said fixture form a respective cap gripper cluster within said arrangement, upon which respective cap gripper cluster a respective displacer can act to transfer a displacement of said switch body into respective displacements of said respective first, second, and third cap grippers.

63. The arrangement for switching an array of cap grippers comprising at least three cap grippers between a one-dimensional array of cap grippers and a two-dimensional array of cap grippers according to claim 53, wherein said switch is a two-way switch, permitting a respective cap gripper of said at least three cap grippers to switch interchangeably between a said respective position of a said respective cap gripper in said one-dimensional array of cap grippers and a said respective position in said two-dimensional array of cap drivers upon operation of said switch.

64. The arrangement for switching an array of cap grippers comprising at least three cap grippers between a one-dimensional array of cap grippers and a two-dimensional array of cap grippers according to claim 53, wherein a respective cap gripper is individually actuated for rotating independently said respective cap gripper in use.

65. The arrangement for switching an array of cap grippers comprising at least three cap grippers between a one-dimensional array of cap grippers and a two-dimensional array of cap grippers according to claim 64, wherein a respective cap gripper comprises a cap socket, a cap gripper pin, and a cap gripper actuator comprising an electro motor engaging said cap gripper pin; said cap gripper pin connecting said cap gripper actuator to said cap socket for transferring a rotation of said electro motor to a rotation of said cap socket.

66. The arrangement for switching an array of cap grippers comprising at least three cap grippers between a one-dimensional array of cap grippers and a two-dimensional array of cap grippers according to claim 53, wherein a respective cap gripper comprises:
a cap gripper actuation part comprising an actuator pin and a cap gripper actuator comprising an electro motor, said actuator pin rotatable by said electro motor; and
a cap gripper socket part comprising a socket pin connecting to a cap socket; said actuator pin and said socket pin respectively comprising a complementary connecting means for releasably connecting said actuator pin and said socket pin, thereby forming said cap gripper from said cap gripper actuation part and said a cap gripper socket part when connected.

67. The arrangement for switching an array of cap grippers comprising at least three cap grippers between a one-dimensional array of cap grippers and a two-dimensional array of cap grippers according to claim 64, wherein a said cap gripper socket part is rotatable comprised within a cap socket cartridge, said cap socket cartridge being configured for connecting to the arrangement for switching an array of cap grippers comprising at least three cap grippers between a one-dimensional array of cap grippers and a two-dimensional array of cap grippers, said cap socket cartridge comprising:
a cap gripper socket part holder comprising at least one socket bearing element comprising a plurality of respective socket bearings for rotatable bearing a plurality of respective cap gripper socket parts; and
a cap ejector displaceable along an axis of cap engagement relative to said cap gripper socket part holder for ejecting respective caps retained on respective cap sockets comprised on respective cap gripper socket parts, by engaging said respective caps when said cap ejector is displaced along said axis of cap engagement away from said cap gripper socket part holder.

68. A cap socket cartridge for connecting to an arrangement according to claim 53 for switching an array of cap grippers comprising at least three cap grippers between a one-dimensional array of cap grippers and a two-dimensional array of cap grippers, said cap socket cartridge comprising:
a cap gripper socket part holder comprising at least one socket bearing element comprising a plurality of respective socket bearings for rotatable bearing a plurality of respective cap gripper socket parts; and
a cap ejector displaceable along an axis of cap engagement relative to said cap gripper socket part holder for ejecting respective caps retained on respective cap sockets comprised on respective cap gripper socket parts, by engaging said respective caps when said cap ejector is displaced along said axis of cap engagement away from said cap gripper socket part holder.

69. The cap socket cartridge according to claim 68 for connecting to an arrangement for switching an array of cap grippers comprising at least three cap grippers between a one-dimensional array of cap grippers and a two-dimensional array of cap grippers, wherein said cap ejector comprises a cap ejector plate, for ejecting said respective caps from said respective cap sockets when said cap ejector is displaced along said axis of cap engagement away from said cap gripper socket part holder.

70. The cap socket cartridge according to claim 68 for connecting to an arrangement for switching an array of cap grippers comprising at least three cap grippers between a one-dimensional array of cap grippers and a two-dimensional array of cap grippers, wherein said cap gripper socket part holder comprises a plurality of respective receptacles arranged in said cap gripper socket part holder for receiving, but not engaging, respective cap gripper actuation parts of respective first cap grippers comprised in said arrangement, when said respective first cap grippers are aligned in said two-dimensional array of cap grippers.

71. A test tube capper-decapper device comprising an arrangement according to claim 53 for switching an array of cap grippers comprising at least three cap grippers between a one-dimensional array of cap grippers and a two-dimensional array of cap grippers.

72. The test tube capper-decapper device according to claim 71, wherein said test tube capper-decapper device is a handheld test tube capper-decapper device.

73. The test tube capper-decapper device according to claim 71 comprising an arrangement for switching an array of cap grippers comprising at least three cap grippers between a one-dimensional array of cap grippers and a two-dimensional array of cap grippers; and a cap socket cartridge, said cap socket cartridge being configured for connecting to the arrangement for switching an array of cap grippers comprising at least three cap grippers between a one-dimensional array of cap grippers and a two-dimensional array of cap grippers, said cap socket cartridge comprising:
a cap gripper socket part holder comprising at least one socket bearing element comprising a plurality of respective socket bearings for rotatable bearing a plurality of respective cap gripper socket parts; and
a cap ejector displaceable along an axis of cap engagement relative to said cap gripper socket part holder for ejecting respective caps retained on respective cap sockets comprised on respective cap gripper socket parts, by engaging said respective caps when said cap ejector is displaced along said axis of cap engagement away from said cap gripper socket part holder.

74. The test tube capper-decapper device according to claim 71, wherein said cap socket cartridge is exchangeable.

75. A kit of parts comprising:
the test tube capper-decapper device according to claim 71 and comprising an arrangement for switching an array of cap grippers comprising at least three cap grippers between a one-dimensional array of cap grippers and a two-dimensional array of cap grippers; and
at least one a cap socket cartridge, said cap socket cartridge being configured for connecting to the arrangement for switching an array of cap grippers comprising at least three cap grippers between a one-dimensional array of cap grippers and a two-dimensional array of cap grippers, said cap socket cartridge comprising:
a cap gripper socket part holder comprising at least one socket bearing element comprising a plurality of respective socket bearings for rotatable bearing a plurality of respective cap gripper socket parts; and
a cap ejector displaceable along an axis of cap engagement relative to said cap gripper socket part holder for ejecting respective caps retained on respective cap sockets comprised on respective cap gripper socket parts, by engaging said respective caps when said cap ejector is displaced along said axis of cap engagement away from said cap gripper socket part holder, and
optionally, a stand for said test tube capper-decapper device.
